(19) United States
(12) Patent Application Publication
(10) Pub. No.: US 2022/0394955 A1
(43) Pub. Date: Dec. 15, 2022

(54) REMOTE ANIMAL TRAINING SYSTEM

(71) Applicant: E-Collar Technologies, Inc., Garrett, IN (US)

(72) Inventors: Greg Van Curen, Fremont, IN (US); Ho-Sung So, Seoul (KR)

(73) Assignee: E-Collar Technologies, Inc., Garrett, IN (US)

(21) Appl. No.: 17/343,039

(22) Filed: Jun. 9, 2021

(51) Int. Cl. A01K 27/00; A01K 15/02

(52) U.S. Cl. CPC A01K 27/009; A01K 15/022; A01K 15/023

(57) ABSTRACT

Disclosed an animal training system including an animal training apparatus worn on an animal to deliver stimulation to the animal, and a remote controller possessed by a user to control the animal training apparatus. The animal training apparatus includes a wireless communication module to receive a signal from the remote controller, a stimulation generator/stimulator module to deliver stimulation to the animal, and a microprocessor to enable the stimulation generator/stimulator module to deliver the stimulation to the animal based on the signal received by the wireless communication module. The remote controller includes a user input means to receive input of an execution instruction for instructing the animal training apparatus to deliver the stimulation according to at least one stimulation mode, a wireless communication module to transmit the signal to the animal training apparatus, and a microprocessor to control the wireless communication module based on the execution instruction. Here, the at least one stimulation mode includes an auto-increasing boost stimulation mode in which the stimulation boosted by a predetermined level than a previous level is delivered to the animal.

### BACKGROUND

The present disclosure relates to a remote electronic animal training system that is worn on the body of an animal such as a dog or a cat to deliver stimulation to train the animal or correct the animal's behavior.

In the field of animal training, owners or trainers (hereinafter referred to as ‘users’) have employed various electric and electronic technologies in correcting animal behaviors since the late 1960s. For example, Patent Literature 1 (U.S. Pat. No. 6,131,535) discloses a control method of an animal training device including a collar type receiver worn on the neck of an animal, and a transmitter or a remote controller possessed by a user to conduct high-frequency wireless communications with the receiver, to allow the user to control the receiver to deliver stimulation such as electrical stimulation to an animal through the transmitter when the animal does a behavior that needs to be corrected, such as barking, going beyond a preset boundary or attacking a human.

The animal training system may be configured to selectively or simultaneously deliver various types of stimulation, for example, electrical stimulation, vibration stimulation and sound stimulation, or adjust the stimulation intensity (level) or duration, according to the animal' behavior or sensitivity to stimulation. For example, Patent Literature 2 (U.S. Pat. No. 8,887,670) discloses a boost stimulation mode that is effectively used when an animal repeatedly does a behavior that needs to be corrected. The boost stimulation mode is a mode in which the collar (receiver) delivers stimulation boosted by a predetermined level than the presently set stimulation level when specific button(s) of the remote controller is pressed. The boost stimulation mode may allow the user to train the animal or correct the animal's behavior in a more convenient manner.

However, the existing boost stimulation mode needs improvement. For example, in the existing boost stimulation mode, each time the user presses the execution button of the boost stimulation mode, the same level (the level that is increased by a predetermined level than the presently set stimulation level) of stimulation is always delivered to the animal. However, when the animal is accustomed to the increased level of stimulation, the boosted stimulation may not be effective in the behavior correction. In this case, after arbitrarily increasing the level, stimulation may be delivered again, or after changing the level that is increased in the boost stimulation mode, the boost stimulation mode may be performed. However, in an emergency situation, in particular, when the user is unable to use his/her hands freely, it is not easy to increase the level or change the level that is increased in the boost stimulation mode, and delayed response occurs.

### SUMMARY

The present disclosure provides an animal training system with improved boost stimulation mode to effectively correct an animal's behavior. According to an aspect of the present disclosure, provided is an auto-increasing boost stimulation mode in which each time stimulation delivery is performed, stimulation boosted by a predetermined level is delivered.

The animal training system according to an aspect of the present disclosure includes an animal training apparatus worn on an animal to deliver stimulation to the animal, and a remote controller possessed by a user to control the animal training apparatus, wherein the remote controller and the animal training apparatus are configured to communicate with each other via wireless communication. Here, the animal training apparatus includes an apparatus side wireless communication module to receive a signal from the remote controller, a stimulation generator/stimulator module to generate stimulation and deliver the stimulation to the animal, and an apparatus side microprocessor to control the stimulation generator/stimulator module to deliver the stimulation to the animal based on the signal received by the apparatus side wireless communication module. Additionally, the remote controller includes a user input means to receive input of an execution instruction for instructing the animal training apparatus to deliver the stimulation according to at least one stimulation mode to the animal, a controller side wireless communication module to transmit the signal to the animal training apparatus, and a controller side microprocessor configured to control the controller side wireless communication module to transmit the signal based on the execution instruction inputted by the user input means. Here, the at least one stimulation mode includes an auto-increasing boost stimulation mode in which the stimulation boosted by a predetermined level than a previous level is delivered to the animal, and when the execution instruction for delivering the stimulation according to the auto-increasing boost stimulation mode is inputted through the user input means, the controller side microprocessor controls the controller side wireless communication module to transmit the signal for delivering the stimulation boosted by the predetermined level than the previous level to the animal training apparatus.

The remote controller may be configured to set or change the predetermined level by which the level is increased in the auto-increasing boost stimulation mode through the user input means.

Additionally, the remote controller may be configured to reset the previous level in the auto-increasing boost stimulation mode to a preset basic level through the user input means.

Additionally, the remote controller may be configured to undo the auto-increasing boost stimulation mode and fix the level of stimulation to be delivered to the animal to a preset basic level through the user input means.

Alternatively, the remote controller may be configured to undo the auto-increasing boost stimulation mode and fix the level of stimulation to be delivered to the animal to the previous level through the user input means.

Additionally, the user input means may include an execution button for receiving input of the execution instruction, and the at least one stimulation mode may include a momentary stimulation mode in which a single stimulation is delivered to the animal for a preset time irrespective of the time during which the execution button is pressed, and a continuous stimulation mode in which stimulation is continuously delivered to the animal for the time during which the execution button is pressed. In this case, the remote controller may be configured to select the momentary stimulation mode or the continuous stimulation mode through the user input means.

Additionally, in this case, the remote controller may be configured to undo the auto-increasing boost stimulation mode and fix the level of stimulation to be delivered to the animal to the previous level or a preset basic level when the continuous stimulation mode is selected through the user input means.

According to an embodiment, the animal training system may include the remote controller and a plurality of identical animal training apparatuses worn on a plurality of animals respectively. In this case, the plurality of animal training apparatuses has different identification information, the remote controller includes an animal selection switch to select the animal training apparatus intended to communicate among the plurality of animal training apparatuses, and the signal includes the identification information of the animal training apparatus selected by the animal selection switch.

According to an aspect of the present disclosure, the stimulation level automatically increases each time stimulation is delivered by the auto-increasing boost stimulation mode, and thus it can be used to train an animal very conveniently and effectively when the animal repeatedly does a behavior that needs to be corrected.

In addition, according to an embodiment, it is possible to find a suitable stimulation level for the animal in a straightforward manner using the auto-increasing boost stimulation mode.

### BRIEF DESCRIPTION OF THE DRAWINGS

FIG. 1 is a perspective view illustrating a remote controller and animal training apparatuses of an animal training system according to an embodiment of the present disclosure.

FIG. 2 is a block diagram illustrating components of the remote controller shown in FIG. 1.

FIG. 3 is a block diagram illustrating components of the animal training apparatus shown in FIG. 1.

FIG. 4 is a diagram for describing a process of selecting a plurality of animal training apparatuses and setting the basic stimulation level of each animal training apparatus according to an embodiment of the present disclosure.

### DETAILED DESCRIPTION

Hereinafter, an animal training system according to the present disclosure is described in detail with reference to the accompanying drawings.

It should be understood that the terms or words used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation. The embodiments described herein and illustrations shown in the drawings are just a most preferred embodiment of the present disclosure but not intended to fully describe the technical aspects of the present disclosure, so it should be understood that other equivalents and modifications could have been made thereto at the time of filing the application.

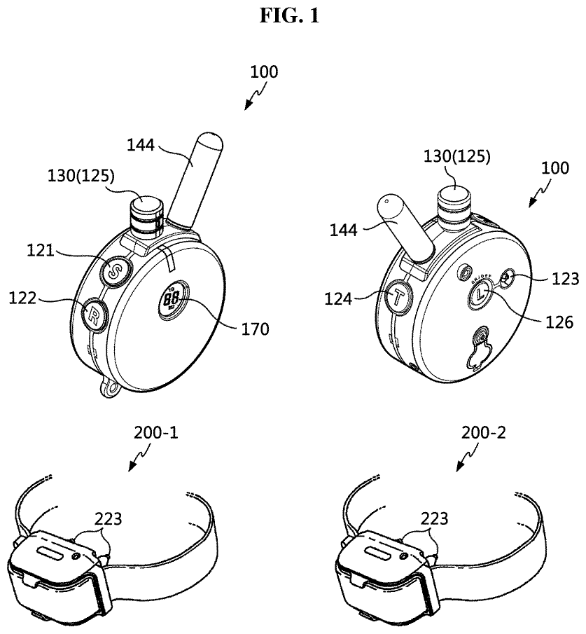

FIG. 1 is a perspective view illustrating a remote controller and animal training apparatuses of an animal training system according to an embodiment of the present disclosure.

Referring to FIG. 1, the animal training system according to this embodiment includes a plurality of animal training apparatuses 200-1, 200-2 (in this embodiment, two animal training apparatuses) and a common (single) remote controller 100. There seems to be two remote controllers 100 in FIG. 1, but one remote controller is shown in different viewing directions.

The remote controller 100 is a transmitter possessed by a user in the general animal training system, and may control the animal training apparatuses 200-1, 200-2 by communication with the animal training apparatuses 200-1, 200-2 via wireless communication. Additionally, each of the two animal training apparatuses 200-1, 200-2 is worn on an animal to train the animal or correct the animal's behavior by delivering stimulation to the animal by the control of the remote controller 100. In this embodiment, the two animal training apparatuses 200-1, 200-2 are substantially the same, except that they have different identification information. Hereinafter, the two animal training apparatuses 200-1, 200-2 may be referred collectively to as an ‘animal training apparatus 200’ when there is no need to separately describe them.

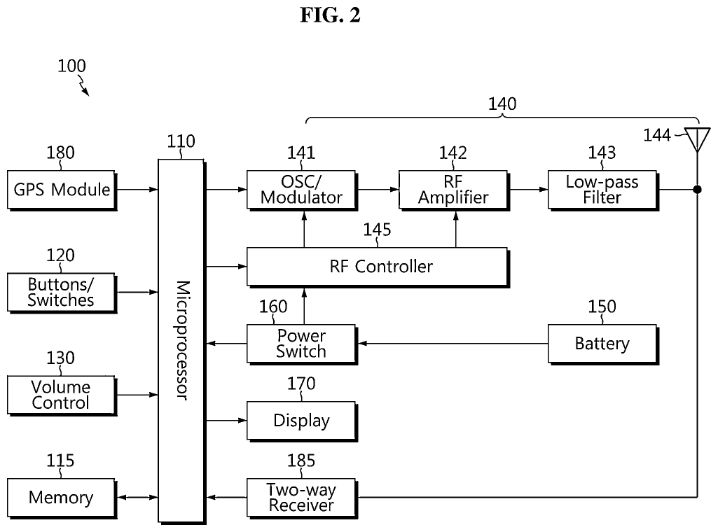

FIG. 2 is a block diagram illustrating the components of the remote controller 100. Referring to FIGS. 1 and 2, the remote controller 100 includes user input means 120, 130, a controller side wireless communication module 140, a controller side microprocessor 110, a battery 150 and a power switch 160.

The user input means 120, 130 includes buttons/switches 120 for selecting or setting at least one stimulation mode including the type, duration and/or level of stimulation that the animal training apparatus 200 will deliver to the animal, or inputting an execution instruction, i.e., a stimulation delivery instruction, and a volume control 130 for adjusting the level. The buttons/switches 120 may include an execution button 121, a reset button 122, an M/C shift button 123, an auxiliary stimulation button 124 and an animal selection switch 125. The buttons/switches 120; 121˜125 will be described in detail below together with the stimulation mode.

Although this embodiment describes the volume control 130 as a knob designed to adjust the stimulation intensity (level) by rotating it with the user's finger, the volume control 130 may be an up/down button type. As described in detail below, in this embodiment, the volume control 130 serves as an animal selection switch 125.

The controller side wireless communication module 140 includes an oscillator/modulator 141, a radio frequency (RF) amplifier 142, a low-pass filter 143, an antenna 144 and a RF controller 145. The oscillator/modulator 141 modulates signals inputted from the controller side microprocessor 110 by a wireless communication method, and the RF amplifier 142 amplifies the RF signals from the oscillator/modulator 141. The low-pass filter 143 blocks harmonics other than the fundamental waves in the amplified RF signals, and the antenna 144 transmits the RF signals composed of the fundamental waves having passed through the low-pass filter 143. Also, the RF controller 145 supplies power to operate the oscillator/modulator 141 and the RF amplifier 142 so as to transmit control signals to the animal training apparatus 200 in response to the input from the user through the user input means 120, 130 of the remote controller 100.

The controller side microprocessor 110 controls the operation of the entire animal training system including the animal training apparatus 200 and the remote controller 100, and in particular, generates a signal indicating stimulation according to the stimulation mode corresponding to the execution instruction inputted by the user input means 120, 130, and controls the controller side wireless communication module 140 to transmit the signal to the animal training apparatus 200. The microprocessor 110 is typically implemented as an integrated circuit (IC) chip, and may have a necessary memory 115 or register, and the operation of the microprocessor 110 may be implemented as control logic programmed in software, firmware, and a hardwired logic. The detailed operation of the microprocessor 110 will be described below together with the stimulation mode.

The memory 115 preferably includes a non-volatile memory device, and may store a program that defines the operation of the microprocessor 110 or data such as the preset stimulation level for each animal training apparatus 200-1, 200-2. Additionally, each time each animal training apparatus 200-1, 200-2 operates, namely, each time the stimulation delivery instruction is executed, the memory 115 may store an operation history including the time of operation and the mode or level of stimulation at that time.

The battery 150 supplies required power to each component of the remote controller 100, especially the controller side microprocessor 110 and the wireless communication module 140, and preferably includes a rechargeable secondary battery.

The power switch 160 is a switch which switches ON/OFF the remote controller 100. The remote controller 100 of this embodiment may further include a display 170. The display 170 may display the type, level and mode of stimulation selected/set by the user input means, and further a remaining amount of the battery 150 of the remote controller 100. Although not necessary, the remote controller 100 of this embodiment may have a global positioning system (GPS) module 180 or a two-way receiver 185. The GPS module 180 may receive signals from a satellite, and display location information of the user, namely, the remote controller 100 on the display 170. When the animal training apparatus 200 includes a GPS module 280 and a two-way transmitter 285 to transmit current location information of the animal or remaining amount information of a battery 250 of the animal training apparatus 200 to the remote controller 100 as described below, the distance and direction from the user to the animal, the movement speed of the animal and the remaining amount information of the battery 250 of the animal training apparatus 200 may be displayed on the display 170.

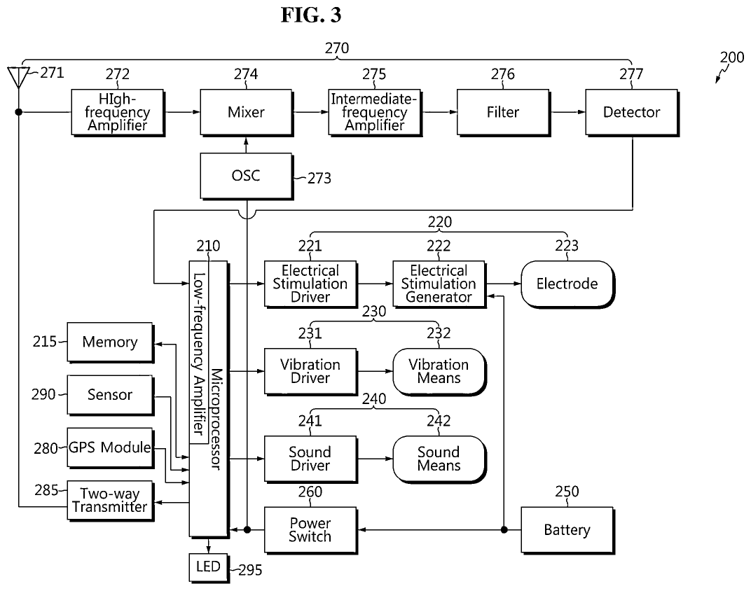

FIG. 3 is a block diagram illustrating the components of the animal training apparatus 200.

Referring to FIGS. 1 and 3, the animal training apparatus 200 according to this embodiment includes a stimulation generator/stimulator module, an apparatus side wireless communication module 270, an apparatus side microprocessor 210, the battery 250 and a power switch 260.

The stimulation generator/stimulator module includes a stimulator means and its driver employed by the general electronic animal training apparatus, and stimulation may be electrical stimulation, vibration stimulation and sound stimulation.

The stimulation generator/stimulator module for delivering electrical stimulation to the animal is implemented as an electrical stimulation generator/stimulator module 220, and specifically, may include an electrical stimulation driver 221, an electrical stimulation generator 222 and two electrodes 223.

The electrical stimulation driver 221 converts a signal of stimulation instructed by a microprocessor 210 to an analog signal recognizable by the electrical stimulation generator 222 and outputs the same to drive the electrical stimulation generator 222. The electrical stimulation generator 222 generates an electrical pulse having current of, for example, from about 50 μA to about 100 mA and voltage of from about 50V to about 10,000V using a transformer. The electrodes 223 are stimulation terminals in contact with the animal's body (typically, the neck) to deliver the electrical pulse generated by the electrical stimulation generator 222 to the animal. The microprocessor 210 may variously adjust the electrical stimulation delivered to the animal by adjusting the intensity (amplitude, voltage), frequency, duration (pulse width), interval, pulse ratio, duty cycle, and repetition ratio of the electrical pulse through the electrical stimulation driver 221 based on the specifications of the electrical stimulation generator 222.

The stimulation generator/stimulator module for delivering vibration stimulation to the animal is implemented as a vibration stimulation generator/stimulator module 230, and specifically, may include a vibration driver 231 and a vibration means 232.

The vibration driver 231 converts a signal of stimulation instructed by the microprocessor 210 to a signal recognizable by the vibration means 232 and outputs the same to drive the vibration means 232. The vibration means 232 is implemented as a vibration motor or a piezoelectric device to generate a vibration pulse. The microprocessor 210 may variously adjust the vibration stimulation delivered to the animal by adjusting the intensity (amplitude), frequency, duration (pulse width), interval, pulse ratio, duty cycle, and repetition ratio of the vibration pulse through the vibration driver 231 based on the specifications of the vibration means 232.

The stimulation generator/stimulator module for delivering sound stimulation to the animal is implemented as a sound stimulation generator/stimulator module 240, and specifically, may include a sound driver 241 and a sound means 242.

The sound deriver 241 converts a signal of stimulation instructed by the microprocessor 210 to a signal recognizable by the sound means 242 and outputs the same to drive the sound means 242. The sound means 242 is implemented as a buzzer, a piezoelectric device or a speaker to generate a sound pulse of frequency audible to the animal. The microprocessor 210 may variously adjust the sound stimulation delivered to the animal by adjusting the intensity (amplitude), frequency, duration (pulse width), interval, pulse ratio, duty cycle, and repetition ratio of the sound pulse through the sound driver 241 based on the specifications of the sound means 242.

Besides, light using a light-emitting diode (LED) lamp or smell using chemicals may be used as a stimulation source. Each of the drivers 221, 231, and 241 and each stimulation generator/stimulator means 222, 232, and 242 driven by the drivers is logically distinguished, and may be physically incorporated into one device.

The apparatus side wireless communication module 270 may include an antenna 271, a high-frequency amplifier 272, an oscillator 283, a mixer 274, an intermediate-frequency amplifier 275, a filter 276 and a detector 277. The antenna 271 receives RF signals transmitted from the remote controller 100, and the high-frequency amplifier 272 amplifies weak RF signals induced into the antenna 271. The oscillator 273 is a self-oscillator for obtaining second intermediate frequency, and signals generated by the oscillator 273 are combined with the RF signals from the high-frequency amplifier 272 by the mixer 274 into second intermediate frequency signals. The intermediate-frequency amplifier 275 amplifies the intermediate frequency signals produced from the mixer 274, and the filter 276 filters out noise from the intermediate frequency signals produced from the mixer 274. The detector 277 detects operation signals and control signals such as ID codes sent from the remote controller 100, and the detected control signal is inputted to the microprocessor 210 through a low-frequency amplifier.

The apparatus side microprocessor 210 controls the operation of the animal training apparatus 200 including the stimulation generator/stimulator modules 220,230,240, and in particular, the microprocessor 210 controls the operation of the stimulation generator/stimulator modules 220,230,240 based on the signal from the remote controller 100 received through the wireless communication module 270. Specifically, the apparatus side microprocessor 210 reads the ID code included in the signal from the remote controller 100, and when the ID code matches its identification information, operates the corresponding stimulation generator/stimulator module 220,230,240 according to the stimulation mode and stimulation level included in the signal to deliver stimulation instructed from the remote controller 100 to the animal.

In the same way as the controller side microprocessor 110, the apparatus side microprocessor 210 is typically implemented as an IC chip, and may have a necessary memory 215 or register, and the operation of the microprocessor 210 may be implemented as control logic programmed in software, firmware, and a hardwired logic.

The battery 250 supplies required power to each component of the animal training apparatus 200, especially the microprocessor 210 and the stimulation generator/stimulator modules 220, 230, and 240, and preferably includes a rechargeable secondary battery.

The power switch 260 is a switch which switches ON/OFF the animal training apparatus 200.

Although not shown in the drawing, the animal training apparatus 200 may be equipped with a lamp or a display to display the remaining amount of the battery 250, the type of the stimulator means or the stimulation mode currently in operation.

The animal training apparatus 200 may further include a sensor 290. The sensor 290 detects the animal's behavior such as barking and a motion, and may include various types of sensors based on a specific behavior intended to detect.

For example, when the animal training apparatus 200 is used as an animal behavior correcting apparatus which detects an animal barking, and to train the animal not to bark, delivers stimulation to the animal, the sensor 290 may be a piezoelectric sensor which detects vocal cords of the animal vibrating or a microphone device which detects the animal barking.

Also, when the animal training apparatus 200 of the present disclosure is used as an animal behavior correcting apparatus which detects an animal going out of a preset area or approaching the area, and to train the animal not to do so, delivers stimulation to the animal, the sensor 290 may be a sensor that senses a signal (electromagnetic wave, ultrasonic wave, infrared light, and so on) from a transmitter (a wire buried in the ground or a high-frequency, ultrasonic or infrared transmitter installed at a point) installed at the area or its boundary, or an image sensor that senses a particular mark installed at the area or its boundary. Further, the sensor 290 may be a gyro sensor or an acceleration sensor that detects a motion of an animal. In this case, the microprocessor 210 may control to change the animal training apparatus 200 to a sleeping mode when the motion sensor does not output a signal for a predetermined time or longer, namely, when the animal does not move for a predetermined time or longer, or on the contrary, when the animal's motion or barking is detected, wake up the animal training apparatus 200 from the sleeping mode.

Although not necessary, the animal training apparatus 200 of this embodiment may have the GPS module 280 or the two-way transmitter 285. The GPS module 280 receives signals from a satellite, and inputs location information of the animal to the microprocessor 210. The two-way transmitter 285 transmits the location information of the animal or information associated with the animal training apparatus 200 such as remaining amount information of the battery 250 to the remote controller 100 through the antenna 271.

Also, although not necessary, the animal training apparatus 200 may have a lighting means 295 such as a LED lamp. The lighting means 295 is a means that is turned on at night to implement a function of allowing for easy detection of the location of the animal (the animal training apparatus), rather than stimulation means which delivers stimulation to the animal. The activation/deactivation of the lighting function of the lighting means 295 (to detect the location of the animal training apparatus) and settings/changes of the lighting time may be made by the user through the remote controller 100.

Subsequently, the operation of the animal training system according to this embodiment will be described in detail together with the operation of the controller side microprocessor 110, the use of the user input means 120, 130 and the stimulation mode.

As described above, the buttons/switches 120 of the user input means may include the execution button 121, the reset button 122, the M/C shift button 123, the auxiliary stimulation button 124 and the animal selection switch 125.

The execution button 121 is used to deliver stimulation according to the presently selected stimulation mode to the animal currently selected by the animal selection switch 125. That is, when the user presses the execution button 121, stimulation according to the presently selected stimulation mode is delivered to the presently selected animal.

The stimulation mode that can be selected in this embodiment includes a momentary stimulation mode and a continuous stimulation mode according to the stimulation duration, and includes a fixed stimulation mode and an auto-increasing stimulation mode according to whether the stimulation level increases or not when the stimulation is delivered.

The momentary stimulation mode is a mode in which a single stimulation is delivered for a preset time regardless the time during which the execution button 121 is pressed, and the continuous stimulation mode is a mode in which stimulation is continuously delivered during the time that the execution button 121 is pressed. The selection (shift) of the momentary stimulation mode and the continuous stimulation mode may be performed by pressing the toggle type M/C shift button 123 for a short duration (for example, 1 sec or less).

The fixed stimulation mode is a mode in which stimulation of the previous level or a preset basic level (the basic level setting method will be described below) is delivered, and the auto-increasing boost stimulation mode is a mode in which stimulation boosted by a predetermined level than the previous level is delivered.

Here, the fixed stimulation mode and the auto-increasing boost stimulation mode are used in combination with the momentary stimulation mode and the continuous stimulation mode. That is, stimulation delivered in the fixed stimulation mode may be momentary stimulation, and may be continuous stimulation. Likewise, stimulation delivered in the auto-increasing boost stimulation mode may be momentary stimulation, and may be continuous stimulation.

The auto-increasing boost stimulation mode is different from the existing simple boost stimulation mode as follows: the existing simple boost stimulation mode delivers stimulation boosted a predetermined level than a preset ‘basic level’, and thus compared to the basic level, the increased stimulation is delivered, but stimulation delivered each time the execution button is pressed is at the same level, while the auto-increasing boost stimulation mode delivers stimulation boosted by a predetermined level than ‘the previous level’, and stimulation delivered each time the execution button 121 is pressed is boosted by the predetermined level. Accordingly, the auto-increasing boost stimulation mode is effective when the animal repeatedly does a behavior that needs to be corrected in spite of the delivery of stimulation boosted by the simple boost stimulation mode.

In the auto-increasing boost stimulation mode, the stimulation level increases each time the execution button 121 is pressed, and in some instances, when the stimulation level increases too much, it may be necessary to lower the stimulation level. Additionally, it may be necessary to shift between the fixed stimulation mode and the auto-increasing boost stimulation mode. In this case, the reset button 122 may be used.

For example, when the reset button 122 is pressed for a short duration (for example, 1 sec or less) a single time in the presently selected auto-increasing boost stimulation mode, ‘the previous level’ may be reset as the basic level while maintaining the auto-increasing boost stimulation mode itself, thereby lowering the increased stimulation level. Additionally, for example, in this state, when the reset button 122 is pressed for a short duration (for example, 1 sec or less) once more, the auto-increasing boost stimulation mode may be shifted to the fixed stimulation mode. In this instance, the level of stimulation delivered according to the fixed stimulation mode may be set as the basic level (or the previous level). Further, for example, after shifted to the fixed stimulation mode, when the reset button 122 is pressed for a short duration (for example, for 1 sec or less) once more, the level of stimulation delivered according to the fixed stimulation mode may be changed to the previous level (or the basic level) while maintaining the fixed stimulation mode, and further, in this state, when the reset button 122 is pressed for a shorter duration (for example, 1 sec or less) once more, the fixed stimulation mode may be shifted to the auto-increasing boost stimulation mode. That is, each time the reset button 122 is pressed, the mode shift and/or stimulation level change may be iteratively performed in a predetermined order.

The mode shift and/or stimulation level change using the reset button 122 may be effectively used to find an appropriate stimulation level for the animal. That is, when the appropriate stimulation level for the animal is reached while increasing the stimulation level by repeatedly pressing the execution button 121 in the auto-increasing boost stimulation mode, the auto-increasing boost stimulation mode may be shifted to the fixed stimulation mode using the reset button 122 and the previous level of stimulation may be set as fixed stimulation to be delivered afterwards.

When the reset button 122 is pressed for a short duration a single time in the presently selected fixed stimulation mode, the fixed stimulation mode may be shifted to the auto-increasing boost stimulation mode.

Besides shifting the mode and/or changing the stimulation level using the reset button 122, when shifted to the continuous stimulation mode using the M/C shift button 123, stimulation according to the fixed stimulation mode may be delivered. That is, the system may be configured to combine the continuous stimulation mode with only the fixed stimulation mode, not the auto-increasing boost stimulation mode. In this instance, the level of stimulation to be delivered afterwards may be the previous level or the basic level.

The following is the reason that the continuous stimulation mode is combined with only the fixed stimulation mode. In the continuous stimulation mode, stimulation is continuously delivered while the execution button 121 is being pressed, so compared to the momentary stimulation mode, the animal may feel stronger stimulation. If the continuous stimulation mode is combined with the auto-increasing boost stimulation mode in which stimulation is boosted each time the execution button is pressed, too much stimulation may be delivered to the animal.

Preferably, the level increased each time the execution button 121 is pressed in the auto-increasing boost stimulation mode, i.e., the ‘predetermined level’, may be set or changed. The setting or change of a level increment may be performed using the M/C shift button 123 or the reset button 122 and the volume control 130. For example, when the M/C shift button 123 or the reset button 122 is pressed for a long duration (for example, 2 sec or more), the display 170 displays the flashing previous level increment or default level increment and a level increment setting mode starts. Subsequently, the user sees the flashing level increment and changes to a desired level increment by rotating the volume control 130. When the display 170 displays the desired level increment, the M/C shift button 123 or the reset button 122 is pressed for a long duration (for example 2 sec or more) again. Then, the flashing level increment is lighted up and set as a new level increment, and the controller side microprocessor 110 stores the newly set level increment in the memory 115.

Although the stimulation mode that can be selected has been hereinabove described as including the momentary stimulation mode, the continuous stimulation mode, the fixed stimulation mode and the auto-increasing boost stimulation mode, the present disclosure is not limited thereto. For example, stimulation mode(s) provided by the existing animal training system such as simple boost stimulation mode may be further included, and on the contrary, the continuous stimulation mode or the fixed stimulation mode may be omitted to reduce the number of necessary buttons/switches and simplify the system.

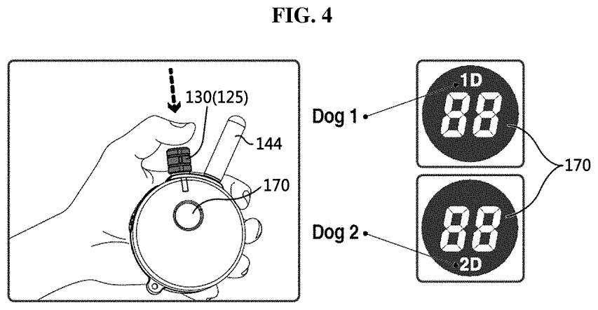

The animal selection switch 125 is a switch 125 for selecting the animal training apparatus intended to communicate among the two animal training apparatuses 200-1, 200-2, i.e., the animal intended to control. In this embodiment, the animal selection switch 125 is not implemented as a separate button or switch, and the volume control 130 serves as the animal selection switch 125. That is, the volume control 130 is configured to turn, and the volume control 130 adjusts the level of stimulation in proportion to its turning amount, but the animal training apparatus 200-1, 200-2 (i.e., the animal) intended to control may be selected in a toggling manner by pressing the volume control 130 (see the arrow in FIG. 4) in its axial direction for a short duration (for example, less than 1 sec). In this instance, the presently selected animal may be displayed on the display 170 of the remote controller 100 (see ‘1D’ or ‘2D’ in FIG. 4), and the user may select, set or execute a desired stimulation mode for the presently selected animal.

In this instance, the remote controller 100 may give the ID code allocated to each animal training apparatus to the signal transmitted from the remote controller 100 to control only the selected animal training apparatus 200-1 or 200-2 (i.e., allow only the selected animal training apparatus to respond to the control by the remote controller). Alternatively, the signal may be transmitted at different communication frequencies for each animal training apparatus 200-1, 200-2.

In general, a plurality of animals controlled by the common remote controller 100 may have different sensitivities against stimulation. Accordingly, whenever an animal to be controlled changes, the stimulation level applied to the selected animal should be appropriately adjusted. However, adjusting the stimulation level whenever a selected animal changes is very cumbersome, and in a case where an urgent control is necessary, the user may fluster and not be able to easily adjust the stimulation level suitably.

In this consideration, the animal training system of this embodiment finds an appropriate stimulation level of each animal through trial and error and sets it as the basic level for the animal, and when any one animal is selected by the animal selection switch 125 and stimulation is delivered, the basic level of stimulation set for the animal is automatically delivered.

The basic level setting may be performed as follows. First, when the animal selection switch 125, i.e., the volume control 130 pressed in its axial direction for a long duration (for example, 2 sec or more), the stimulation level displayed on the display 170 flashes and the basic level setting mode starts. Subsequently, the user changes to a desired level by rotating the volume control 130 while seeing the flashing stimulation level. When the stimulation level on the display 170 is changed to the desired level, the animal selection switch 125, i.e., the volume control 130 is pressed in its axial direction for a long duration (for example, 2 sec or more) again. Then, the flashing stimulation level is changed to the light-up state, the stimulation level is set as the basic level, and the controller side microprocessor 110 stores the set basic level in the memory 115.

Although the number of animals that can be selected has been hereinabove described as two (i.e., the number of animal training apparatuses that can be selected is two), the present disclosure is not limited thereto and three or more animals may be selected. In this case, each time the animal selection switch 125 is pressed, animals may be iteratively selected in this way, for example, ‘dog 1->dog 2->->dog n->dog 1’.

On the contrary, only one animal training apparatus 200 may be controlled by one remote controller 100 to simplify the animal training system. In this case, the animal selection switch 125 is unnecessary.

Additionally, although the volume control 130 has been hereinabove described as serving as the animal selection switch 125 and the basic level setting button, the present disclosure is not limited thereto, and the animal selection switch 125 and the basic level setting button may be equipped separately from the volume control 130.

When the animal training apparatus 200 can deliver at least two stimulation means (for example electrical stimulation and vibration stimulation) to the animal, any one stimulation means (for example, electrical stimulation) may be set as main stimulation and the other (for example, vibration stimulation) may be set as auxiliary stimulation. The auxiliary stimulation button 124 is used to deliver the auxiliary stimulation to the animal. Generally, the auxiliary stimulation is weaker than the main stimulation. Accordingly, the above-described various stimulation modes are not applied as the auxiliary stimulation, and the intensity (level) of the auxiliary stimulation cannot be changed, thereby simplifying the system. However, the continuous stimulation mode may be applied to the auxiliary stimulation. While the auxiliary stimulation button 124 is being pressed, the auxiliary stimulation may be continuously delivered.

In FIG. 1, the reference numeral ‘126’ is a light button used to turn on/off (activate/deactivate) the lighting means 295 of the animal training apparatus 200. As the lighting means 295 is turned on using the light button 126, it is possible to deliver another type of stimulation to the animal, or easily identify the location of the animal (the animal training apparatus) at night.

Hereinabove, the animal training system according to the present disclosure has been described. While the present disclosure has been described by particular embodiments, various modifications and changes may be made to the present disclosure by person having ordinary skill in the technical field to which the present disclosure belongs without departing from the spirit and scope of the present disclosure. Therefore, the present disclosure is not limited to the scope narrower than the scope of the appended claims.

What is claimed is:

1. An animal training system comprising:
an animal training apparatus worn on an animal to deliver stimulation to the animal; and
a remote controller possessed by a user to control the animal training apparatus,
wherein the remote controller and the animal training apparatus are configured to communicate with each other via wireless communication,
wherein the animal training apparatus comprises:
an apparatus side wireless communication module to receive a signal from the remote controller;
a stimulation generator/stimulator module to generate stimulation and deliver the stimulation to the animal; and
an apparatus side microprocessor to control the stimulation generator/stimulator module to deliver the stimulation to the animal based on the signal received by the apparatus side wireless communication module,
the remote controller comprises:
a user input means to receive input of an execution instruction for instructing the animal training apparatus to deliver the stimulation according to at least one stimulation mode to the animal;
a controller side wireless communication module to transmit the signal to the animal training apparatus; and
a controller side microprocessor configured to control the controller side wireless communication module to transmit the signal based on the execution instruction inputted by the user input means,
the at least one stimulation mode includes an auto-increasing boost stimulation mode in which the stimulation boosted by a predetermined level than a previous level is delivered to the animal, and
when the execution instruction for delivering the stimulation according to the auto-increasing boost stimulation mode is inputted through the user input means, the controller side microprocessor controls the controller side wireless communication module to transmit the signal for delivering the stimulation boosted by the predetermined level than the previous level to the animal training apparatus.

2. The animal training system according to claim 1, wherein the remote controller is configured to set or change the predetermined level by which the level is increased in the auto-increasing boost stimulation mode through the user input means.

3. The animal training system according to claim 1, wherein the remote controller is configured to reset the previous level in the auto-increasing boost stimulation mode to a preset basic level through the user input means.

4. The animal training system according to claim 1, wherein the remote controller is configured to undo the auto-increasing boost stimulation mode and fix the level of stimulation to be delivered to the animal to a preset basic level through the user input means.

5. The animal training system according to claim 1, wherein the remote controller is configured to undo the auto-increasing boost stimulation mode and fix the level of stimulation to be delivered to the animal to the previous level through the user input means.

6. The animal training system according to claim 1, wherein the user input means includes an execution button for receiving input of the execution instruction,
the at least one stimulation mode includes a momentary stimulation mode in which a single stimulation is delivered to the animal for a preset time irrespective of the time during which the execution button is pressed, and a continuous stimulation mode in which stimulation is continuously delivered to the animal for the time during which the execution button is pressed, and
the remote controller is configured to select the momentary stimulation mode or the continuous stimulation mode through the user input means.

7. The animal training system according to claim 6, wherein the remote controller is configured to undo the auto-increasing boost stimulation mode and fix the level of stimulation to be delivered to the animal to the previous level or a preset basic level when the continuous stimulation mode is selected through the user input means.

8. The animal training system according to claim 1, wherein the animal training system comprises the remote controller and a plurality of identical animal training apparatuses worn on a plurality of animals respectively,
the plurality of animal training apparatuses has different identification information,
the remote controller includes an animal selection switch to select the animal training apparatus intended to communicate among the plurality of animal training apparatuses, and
the signal includes the identification information of the animal training apparatus selected by the animal selection switch.
